(19) United States
(12) Patent Application Publication
(10) Pub. No.: US 2026/0196746 A1
(43) Pub. Date: Jul. 9, 2026

(54) SPRING-LOADED TERMINAL CONNECTION AND CONDUCTOR CONNECTION TERMINAL

(71) Applicant: WAGO Verwaltungsgesellschaft mbH, Minden (DE)

(72) Inventor: Michael MEYER, Wiedensahl (DE)

(73) Assignee: WAGO Verwaltungsgesellschaft mbH, Minden (DE)

(21) Appl. No.: 19/441,308

(22) Filed: Jan. 6, 2026

(30) Foreign Application Priority Data
Jan. 9, 2025 (DE) 20 2025 100 085.7

(51) Int. Cl. H01R 4/48; H01R 11/22

(52) U.S. Cl. CPC H01R 4/483; H01R 4/4811; H01R 4/48365; H01R 4/48455; H01R 4/4852; H01R 11/22

(57) ABSTRACT

A spring-loaded terminal connection to connect at least one electrical conductor via spring force, having at least one bus bar and a clamping spring. The bus bar has a contact section for clamping the electrical conductor and the clamping spring has a clamping leg with a clamping edge for pressing the electrical conductor against the contact section. The clamping spring has a spring bend adjoining the clamping edge and has, adjoining the spring bend, a holding section that is attached to the bus bar via an attachment section. The attachment section is angled toward the contact section with respect to the holding section. A conductor connection terminal is also provided having such a spring-loaded terminal connection.

This nonprovisional application claims priority under 35 U.S.C. § 119(a) to German Patent Application No. 20 2025 100 085.7, which was filed in Germany on January 9, 2025, and which is herein incorporated by reference.

### BACKGROUND OF THE INVENTION

### Field of the Invention

The invention relates to a spring-loaded terminal connection for connecting at least one electrical conductor via spring force, having at least one bus bar and a clamping spring, wherein the bus bar has a contact section for clamping the electrical conductor and the clamping spring has a clamping leg with a clamping edge for pressing the electrical conductor against the contact section, wherein the clamping spring has a spring bend adjoining the clamping edge and has, adjoining the spring bend, a holding section that is attached to the bus bar via an attachment section, wherein the attachment section is angled toward the contact section with respect to the holding section. The invention also relates to a conductor connection terminal having such a spring-loaded terminal connection.

### Description of Background Art

A spring-loaded terminal connection and a conductor connection terminal are known, for example, from WO 2014/124962 A1, which corresponds to US 2015/0372401, which is incorporated herein by reference.

### SUMMARY OF THE INVENTION

It is therefore an object of the invention to provide a spring-loaded terminal connection that is further improved in comparison therewith, and a conductor connection terminal.

In an example, this object is attained in a spring-loaded terminal connection in that the bus bar has at least one projecting support arm, against which at least a part of the attachment section comes to rest and is supported as a result. In this way, the attachment section can be held especially securely in a desired position relative to the contact section of the bus bar. The attachment section, and thus also the clamping spring, is held in a desired position via the at least one support arm.

The bus bar can have at least two spaced apart, projecting support arms, against each of which at least a part of the attachment section comes to rest and is supported as a result. In this way, the advantageous shaping of the attachment section with the spaced apart tension arms is continued at the support arms in the region of the bus bar. As a result, the relatively delicate tension arms can be well supported. Furthermore, sufficient free space is also provided on the bus bar side for passing through the electrical conductor that is to be clamped.

The clamped electrical conductor can be passed through between the two spaced apart, projecting support arms.

A respective support arm can make contact with a tension arm, associated with the support arm, of the attachment section. The respective support arm can extend parallel to the tension arm in this case.

The attachment section can have at least one through opening through which the electrical conductor that is to be clamped can be fed. In contrast to the aforementioned prior art, in which the attachment section forms a conductor-receiving pocket that is closed in the conductor insertion direction, the spring-loaded terminal connection according to the invention makes possible a feeding of the electrical conductor through the through-opening. Accordingly, the at least one through opening can also be placed and dimensioned such that, when the spring-loaded terminal connection is used as intended, the electrical conductor, which is inserted in a predefined conductor insertion direction, is fed through the through opening. As a result, the spring-loaded terminal connection can be designed more compactly, in particular can be shorter in the conductor insertion direction. As a result, it is additionally possible to achieve a saving in the material of the attachment section, and bus bar material can potentially also be saved.

In the state in which it is clamped to the spring-loaded terminal connection, the electrical conductor can project through the through opening, in particular. A clamping point at which the electrical conductor can be clamped in place between the contact section and the clamping edge can be located in front of or behind the attachment section in the conductor insertion direction, for example, or at the same level as the attachment section.

Another advantage of the invention is that the through opening in the attachment section permits simple integration of an automatic conductor connection function in the spring-loaded terminal connection, which is to say an automatic triggering of a clamping leg held in the open position on a holding element when an electrical conductor is inserted.

The holding section, together with the attachment section, serves to hold the clamping spring and, in particular, to support the clamping spring with respect to the clamping force that is applied by the clamping leg and acts toward the contact section. In an example, the attachment section can be loaded only with a tensile force, which is to say no compressive forces occur in the attachment section in normal operation of the spring-loaded terminal connection, at least in the region of the attachment section that surrounds the at least one through opening.

The attachment section can have two spaced apart, narrow, elongated tension arms, between which is formed an intermediate space, creating the at least one through opening through which the electrical conductor that is to be clamped can be fed. The tension arms are equipped to absorb only tensile forces. Accordingly, the tension arms can be designed to be relatively delicate because they do not require the flexural rigidity necessary for absorbing compressive forces. In this way, with a simple configuration of the spring-loaded terminal connection, the desired through opening can be provided and at the same time the attachment section can be designed in a material-saving manner.

The electrical conductor to be clamped can be inserted into the spring-loaded terminal connection in a conductor insertion direction that runs essentially parallel to the longitudinal extent of the contact section. In this way, good contact of the electrical conductor on the contact section, and thus good current transfer, is possible.

The attachment section can extend from the holding section toward the contact section at an angle to the conductor insertion direction in the range from 60° to 120°, in particular in the range from 80° to 100°. In this way, the clamping spring, together with the attachment section, can extend back toward the bus bar in the shape of a loop, which likewise is beneficial for compact construction.

The attachment section can be formed in one piece with the clamping spring, in particular with the holding section, or is designed as a separate component from the clamping spring. When the attachment section is designed as a separate component, the clamping spring can have relatively simple shaping, and accordingly be produced with simple stamping and bending steps. Furthermore, it is possible for the clamping spring and the attachment section to be made from different materials, or at least from materials that are treated differently. Accordingly, one of these components can, for example, be hardened by tempering, or both components can also be hardened by tempering, potentially with different hardnesses. In this way, the attachment section can be designed as a retaining frame for holding the clamping spring on the bus bar.

When the clamping spring is formed in one piece with the attachment section, installation of the components is simplified because only one assembly is to be installed. In this case, the clamping spring as a whole can be designed as a component that is bent in the shape of a loop.

At least one actuating section can be formed on the clamping leg, at which section the clamping leg can, through action by an actuating element, be shifted from a clamping position into an open position in which the clamping edge of the clamping leg is moved away from the contact section relative to the clamping position. In this way, a defined part of the clamping spring or of the clamping leg is made available for manual actuation. It is fundamentally also possible for the clamping leg to be formed with no actuating section. In this case, manual actuation can be accomplished through direct action on the clamping leg.

The at least one actuating section can be formed on the clamping leg as a tab that is flared or bent out. For example, an actuating section can be formed on the clamping leg on each opposing lateral edge. This permits symmetrical actuation of the clamping leg so that tilting is avoided.

The at least one actuating section can extend at an angle to the conductor insertion direction in the range of +/- 30°, at least in the open position. This makes possible an advantageous direction of actuation of the manual actuating section and correspondingly good force transmission.

The actuation of the clamping leg can be carried out via a separate tool, which then serves as the actuating element.

The spring-loaded terminal connection can have a manual actuating element for shifting the clamping leg into the open position, wherein the manual actuating element has a manual actuating section at which the manual actuating element is to be actuated manually. This has the advantage that the spring-loaded terminal connection has its own actuating element, which can be optimized in the best possible way with regard to design for simple and reliable actuation of the clamping leg. Moreover, an actuating element is always present, so that the user does not first need a separate tool.

Provision can also be made that the manual actuating element forks, starting from the manual attachment section, into two spaced apart, essentially parallel actuating arms, each of which has a spring action section for the application of force to an actuating section of the clamping spring. Such a forked actuating element can be integrated into a compact conductor connection terminal in a beneficial and space-saving manner. For example, the actuating element can, with its actuating arms, reach around parts of the spring-loaded terminal connection, for example the contact section or another part of the bus bar and/or a part of the clamping spring.

The spring-loaded terminal connection can have, as a manual actuating element, a displaceable actuating pusher that is movable in a direction of displacement. This permits simple and ergonomically beneficial actuation of the clamping leg through application of a compressive force to the manual actuating section of the actuating pusher. The actuating pusher can be displaceable in a linear direction, for example. For this purpose, the actuating pusher can be displaceably supported in an actuating shaft of an insulating housing of a conductor connection terminal in which the spring-loaded terminal connection is arranged.

The direction of displacement of the actuating pusher can extend at an angle to the conductor insertion direction in the range from 60° to 120°, in particular in the range from 80° to 100°. This permits an especially beneficial and direct transmission of force from the actuating pusher to the clamping leg. In this design, forces are largely kept away from any insulating housing that may surround the spring-loaded terminal connection so that the material of the insulating housing is not stressed unnecessarily. The direction of displacement of the actuating pusher can be essentially orthogonal to the conductor insertion direction, for example.

The spring-loaded terminal connection can have a pivotable actuating lever as a manual actuating element. Simple and ergonomic actuation of the clamping leg is possible by this means as well. Such an actuation is especially advantageous for spring-loaded terminal connections that are designed for large conductor cross-sections because the actuating forces can be kept within reasonable limits through appropriate design of the lever length of the actuating lever, even with very strong clamping springs.

The manual actuating section of the actuating lever can project from the spring-loaded terminal connection at the side of the spring bend of the clamping spring. Accordingly, the user can actuate the actuating lever in the region of the spring bend. If the spring-loaded terminal connection is arranged in an insulating housing of a conductor connection terminal, the manual actuating section can protrude from the insulating housing on the side on which the spring bend is located in the insulating housing. The manual actuating section can project in a direction pointing away from the attachment section, in particular.

The spring-loaded terminal connection can have a holding element for holding the clamping leg in the open position. This has the advantage that the clamping leg can be held in the open position over a relatively long period by the holding element, even without the necessity for a manual actuation of the actuating element to be maintained. It is also possible for the manufacturer to ship the spring-loaded terminal connection, or a conductor connection terminal made therewith, with the clamping leg already in the open position, so that the user can clamp the electrical conductor even more simply and quickly. This is associated with a substantial time advantage, in particular for extensive wiring tasks.

The spring-loaded terminal connection can have a release element with a release section, by which means the clamping leg held on the holding element can be released from the holding element when a release force is applied to the release section. In this way, the spring-loaded terminal connection can be advantageously designed with an automatic triggering function for the conductor connection. The electrical conductor inserted in the conductor insertion direction can then press against the release section with a release force, and thereby shift the holding element and/or the clamping leg via the release element in such a manner that the clamping leg releases from the holding element and springs back and thus clamps the electrical conductor against the contact section.

The release element can be formed in one piece with the holding element. This permits simple and economical manufacture of the release element and holding element components. For example, the holding element and the release element can be formed into a combined holding/release element.

The release section is arranged behind the attachment section in the conductor insertion direction. Advantageously, the electrical conductor can then be passed through the at least one through opening in the attachment section during insertion in the conductor insertion direction, and then strikes the release section in a desired manner so as to accomplish the automatic release of the clamping leg from the holding element in this way.

The holding element can be formed in one piece with the attachment section. This makes possible an especially advantageous provision of an assembly composed of the attachment section and the holding element, potentially with the release element in addition. For example, the holding element, together with the release element, can be stamped and bent from the inner region of the attachment section as a material tab. By this means, the at least one through opening is formed more or less automatically in the attachment section. For example, the holding element can branch off from the attachment section at a relatively small, acute angle. The release element can be bent at a larger angle as compared with the holding element, for example at an angle of 45 to 90°. The release section can then extend, substantially orthogonally to the conductor insertion direction, from a connecting region of the release element that connects the release section to the end of the holding element.

The bus bar can have a main body that is designed as an elongated, flat, essentially smooth sheet metal part and/or that constitutes the majority of the bus bar, wherein the contact section projects essentially in a straight line from the main body. This permits simple and economical manufacture of the bus bar. In particular, the bus bar can be designed in a relatively material-saving manner.

The attachment section can engage behind the bus bar on the side facing away from the clamping leg. For example, the attachment section can have, at its end facing the bus bar, at least one bent or angled securing section with which the attachment section engages behind the bus bar. The bus bar is gripped between the attachment section and the clamping leg in this way so that a self-supporting spring-loaded terminal connection can be provided in which any insulating housing that may be present essentially is not stressed with forces of the clamping spring, at least when the clamping leg is in the clamping position.

The above-mentioned object is additionally attained by a conductor connection terminal having an insulating housing and having a spring-loaded terminal connection of the type explained above that is arranged at least mostly in the insulating housing, wherein the insulating housing has a conductor insertion opening through which an electrical conductor can be guided in the conductor insertion direction to a clamping point between the contact section and the clamping edge. The advantages explained above can also be realized herewith.

The conductor connection terminal can have an unlocking actuator, by which means the clamping leg held on the holding element can be released from the holding element upon manual actuation. Via such an unlocking actuator, it is possible to provide, on the conductor connection terminal, an additional, manually actuatable actuating element that can be actuated by the user when the clamping leg is to be released from the holding element in a defined manner without using the release section of the release element to accomplish this. The clamping leg can, e.g., be released from the holding element with the unlocking actuator if sufficient force for actuating the release section cannot be transmitted by the inserted electrical conductor, for example because the electrical conductor does not have sufficient rigidity. An unlocking of the clamping leg is also possible entirely without an electrical conductor by the means that the unlocking actuator is simply actuated manually.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a spring-loaded terminal connection in a side view,

FIG. 2 shows the spring-loaded terminal connection from FIG. 1 in a perspective view with an actuating element,

FIG. 3 shows a conductor connection terminal in a side view in the clamping position,

FIG. 4 shows the conductor connection terminal from FIG. 3 in the open position,

FIG. 5 shows an example of a spring-loaded terminal connection in a side view,

FIG. 6 shows the spring-loaded terminal connection from FIG. 5 in a perspective view with an actuating element,

FIG. 7 shows a conductor connection terminal in a side view in the clamping position,

FIG. 8 shows the conductor connection terminal from FIG. 7 in the open position,

FIG. 9 shows an example of a clamping spring in a perspective view,

FIG. 10 shows the clamping spring from FIG. 9 with an attachment section,

FIG. 11 shows an example of a spring-loaded terminal connection in a perspective view with an actuating element,

FIG. 12 shows an example of a conductor connection terminal in a side view in the clamping position, and

FIG. 13 shows the conductor connection terminal from FIG. 12 in the open position.

### DETAILED DESCRIPTION

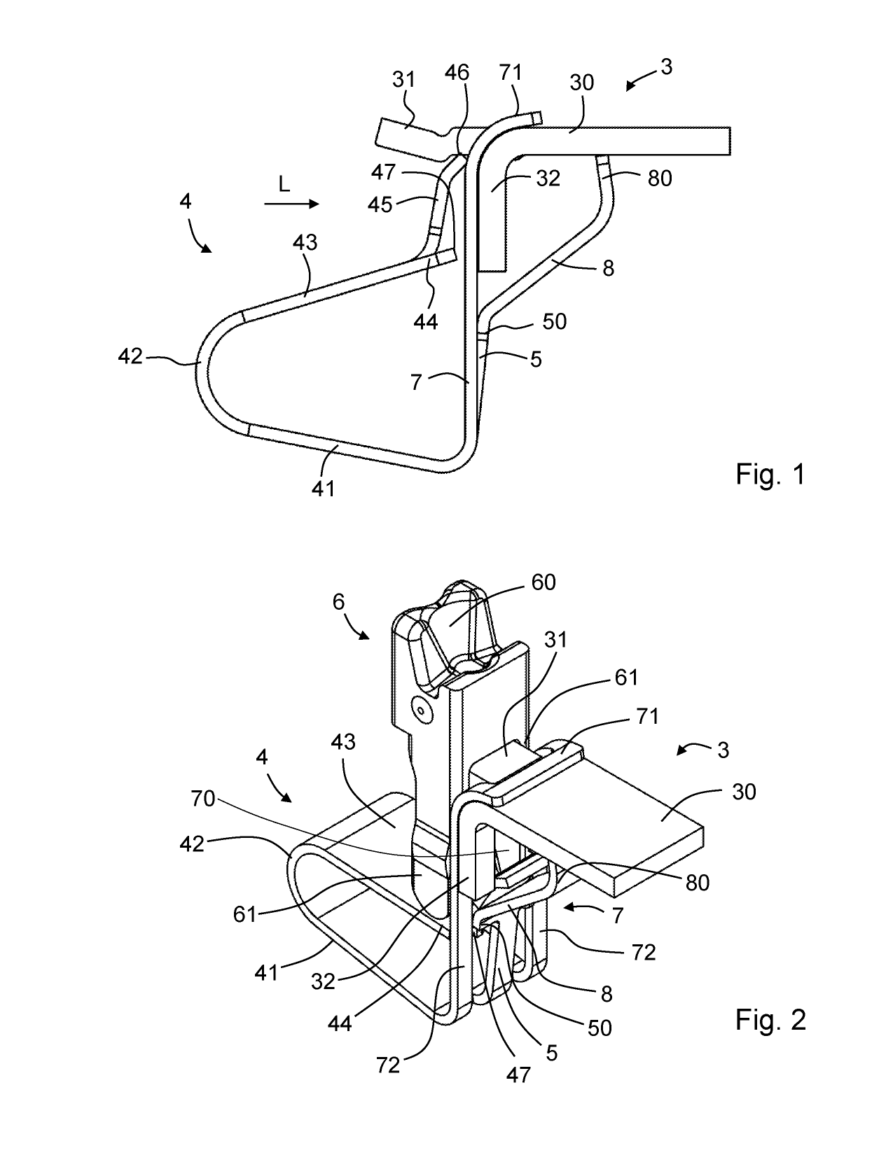

The spring-loaded terminal connection shown in FIG. 1 has a bus bar 3 and a clamping spring 4 attached to the bus bar 3. The bus bar 3 has a main body 30, which comprises the largest part of the bus bar 3 in terms of area. The main body 30 is designed as an elongated, flat, essentially smooth body. From the main body 30, a contact section 31 projects, for example essentially in a straight line from the main body 30. The contact section 31 serves to clamp an electrical conductor to the bus bar 3. The bus bar 3 additionally has at least one support arm 32, which projects from the main body 30 and is angled with respect to the main body 30, for example is angled essentially at right angles. For example, a support arm 32 can be formed to both the left and the right of the contact section 31. The support arms 32 can be spaced apart from one another such that a clamped electrical conductor is passed through between the support arms 32.

The clamping spring 4 has a clamping leg 43 for clamping the electrical conductor to the contact section 31. The clamping leg 43 can have a clamping tab 45 toward the free end. Arranged at the end of the clamping leg 43 or the clamping tab 45 is a clamping edge 46 that serves to clamp the electrical conductor. At the opposite end, the clamping leg 43 transitions into a spring bend 42 of the clamping spring 4. The spring bend 42 is configured to carry out the main part of the bending motion of the clamping spring 4 during a deflection of the clamping leg 43 from the clamping position shown in FIG. 1 into an open position and vice versa. The spring bend 42 transitions into a holding section 41 of the clamping spring 4. The clamping spring 4 can be formed as a spring component in one piece with the holding section 41, the spring bend 42, and the clamping leg 43.

An electrical conductor can be inserted into the spring-loaded terminal connection in a conductor insertion direction L and be clamped in place at a clamping point that is formed between the clamping edge 46 and the contact section 31.

The spring-loaded terminal connection has an attachment section 7, which extends toward the bus bar 3 from the end of the holding section 41 facing away from the spring bend 42. The attachment section 7 has a securing section 71, with which the attachment section 7 is attached to the bus bar 3. The securing section 71 can be fastened behind the contact section 31, for example. Over a substantial portion of its length, the attachment section 7 extends essentially in a straight line and in doing so assumes an angle with respect to the conductor insertion direction L in the range from 60 to 120°.

The spring-loaded terminal connection additionally has a holding element 5, which has a first latching element 50. Furthermore, the spring-loaded terminal connection has a release element 8, which has a release section 80. Formed on the clamping leg 43 is at least one actuating section 44, at which the clamping leg 43 can be actuated by a manual actuating element in order to deflect it into the open position. The clamping leg 43 additionally has at least one second latching element 47, with which the clamping leg 43 can be latched onto the first latching element 50 in the open position. Via this latching, the clamping leg 43 can be held in the open position on the holding element 5, even without manual actuation of the clamping leg taking place. The at least one second latching element 47 can be designed as a latching edge on the free end of the actuating section 44, for example.

In FIG. 2, the spring-loaded terminal connection from FIG. 1 is shown in the open position, in which the clamping leg 43 is latched onto the holding element 5. As can be seen, the attachment section 7 has a through opening 70. The electrical conductor that is to be clamped can be fed through this through opening 70. The through opening 70 is, as can be seen, relatively wide, so that the attachment section 7 in this region is formed only by two lateral, elongated, thin tension arms 72, which extend from the holding section 41 to the bus bar 3. In the region of the bus bar 3, the tension arms 72 are connected to one another by a cross-connection section that constitutes the securing section 71.

It can be seen that the tension arms 72 are supported on the support arms 32 and are positioned against them in order to thus stabilize the clamping spring 4. The support arms 32 are spaced apart from one another so that the passage between the support arms 32 at least substantially aligns with the through opening 70, and an electrical conductor to be inserted is passed through between the support arms 32.

It can be seen that the holding element 5 is formed in one piece with the attachment section 7. In addition, the release element 8 is formed in one piece with the holding element 5. In the example depicted, the holding element 5, together with the release element 8, is flared out as a multiply bent material section from the middle region of the original sheet metal material of which the attachment section 7 is made, and is bent into the shape shown. In this way, the holding element 5 with the release element 8 is elastically movable relative to the attachment section 7 and, in particular, can be deflected by the means that an electrical conductor inserted in the conductor insertion direction L is passed through the through opening 70 and is pressed against the release section 80. As a result, the release element 8 can be deflected in a pivoting movement, causing the holding element 5 with the first latching element 50 to be deflected at the same time. Via this deflection movement, the latching of the second latching element 47 on the first latching element 50 can be terminated, by which means the clamping leg 43 can be released from the latched open position and can spring back into the clamping position, for example in order to clamp an electrical conductor in place.

FIG. 2 additionally shows, as part of the spring-loaded terminal connection, a manual actuating element 6 that is designed as a linearly displaceable actuating pusher. The manual actuating element 6 has a manual actuating section 60. Starting from the manual actuating section 60, the manual actuating element 6 forks into two spaced apart actuating arms 61, each of which surrounds the contact section 31 and extends in each case to an actuating section 44 of the clamping leg 43. The actuating arms 61 each have, at their free ends, a spring action section with an arched, convex external surface, by which means they can each apply an actuating force to an actuating section 44 of the clamping spring.

In the example shown, the actuating element 6 or the actuating arms 61 can slide along the tension arms 72 and/or be supported on the tension arms 72.

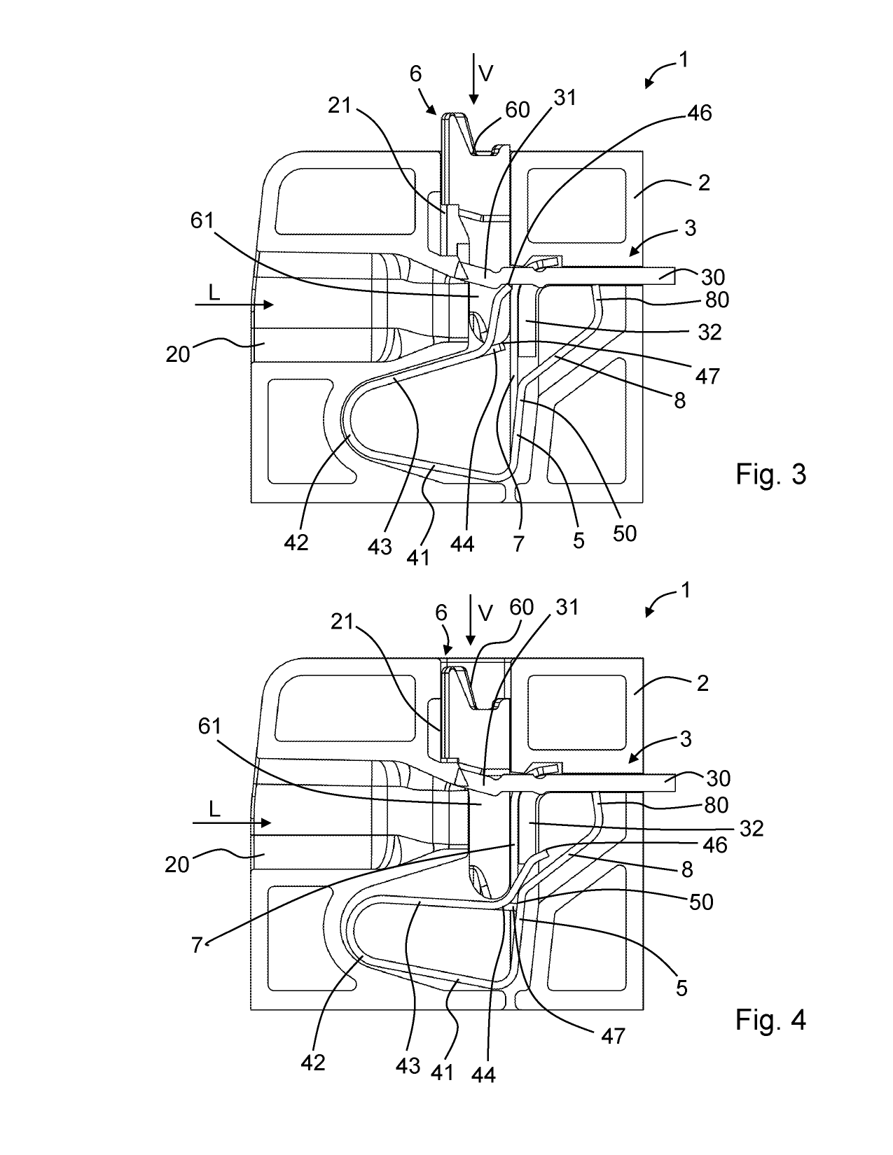

FIG. 3 shows a spring-loaded terminal connection from FIG. 2 as part of a conductor connection terminal 1 that has an insulating housing 2. The spring-loaded terminal connection in this case is arranged largely within the insulating housing 2. In this design, the manual actuating section 60 can of course be actuated on the outside of the insulating housing. The insulating housing 2 has a conductor insertion opening 20, into which an electrical conductor can be inserted into the insulating housing 2 in the conductor insertion direction L, and be guided in this way to the clamping point between the clamping edge 46 and the contact section 31. The insulating housing 2 has an actuating shaft 21, in which the manual actuating element 6 is guided in a displacement direction V. The conductor insertion direction L is essentially perpendicular to the displacement direction V. FIG. 3 shows the conductor connection terminal 1 with a spring-loaded terminal connection in the clamping position.

FIG. 4 shows the conductor connection terminal from FIG. 3 after transitioning of the spring-loaded terminal connection into the open position through actuation of the manual actuating element 6. The clamping leg 43 is latched onto the holding element 5. If an electrical conductor is now inserted through the conductor insertion opening 20 into the insulating housing 2 and its free end is pressed against the release section 80, the latching of the clamping leg 43 on the holding element 5 is terminated as a result and the electrical conductor is clamped in place on the contact section 31 by the clamping edge 46 by this means.

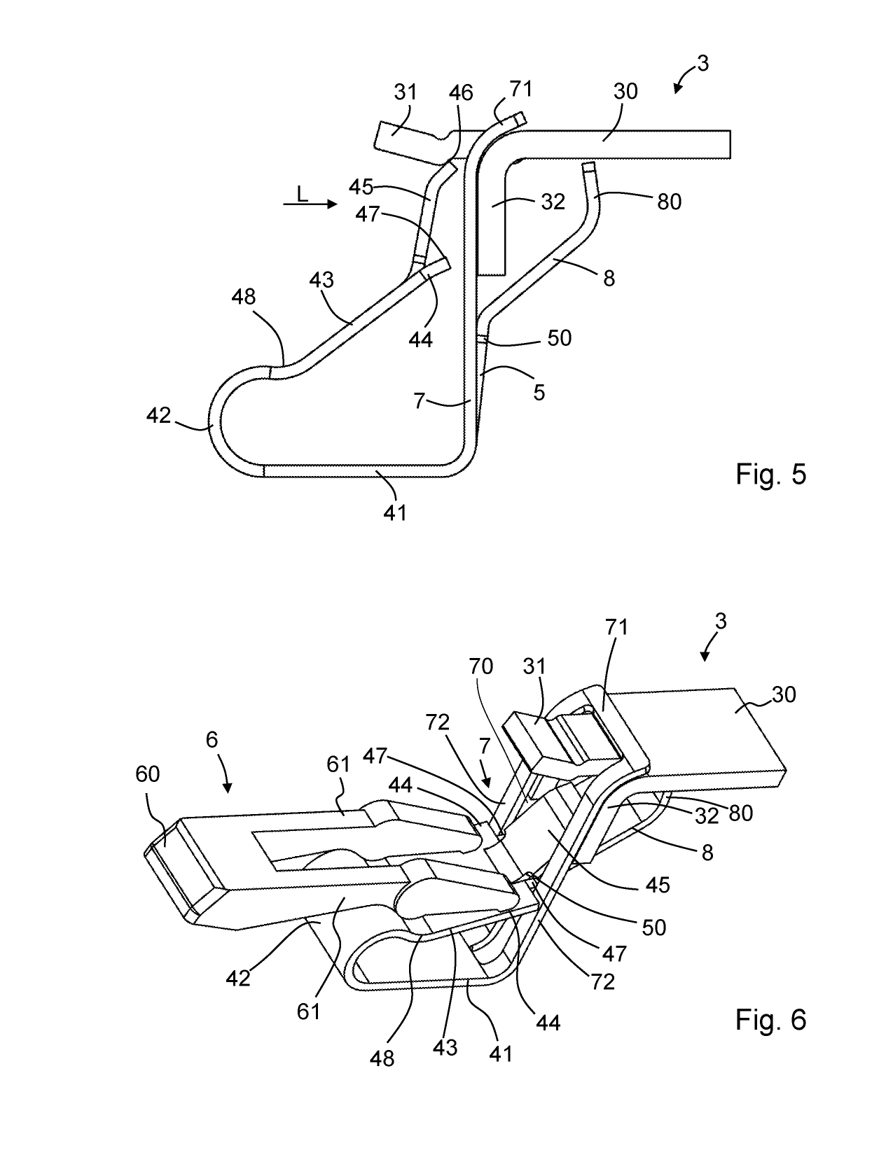

FIG. 5 shows another example of a spring-loaded terminal connection, which is substantially similar to the example from FIG. 1. FIG. 5 shows the spring-loaded terminal connection in the clamping position. In contrast to FIG. 1, the clamping spring 4 is shaped a little differently in the transition from the spring bend 42 to the clamping leg 43. Whereas a transition from the spring bend 42 to the clamping leg 43 in the example from FIG. 1 is realized with a monotonic change in curvature, a concave depression 48 that has a curvature opposite the direction of curvature of the spring bend 42 is formed at this transition in the example from FIG. 5. As explained below, this depression 48 is helpful for the implementation of a spring-loaded terminal connection with lever actuation.

FIG. 6 shows the spring-loaded terminal connection from FIG. 5 in the open position, in which the clamping leg 43 is latched onto the holding element 5. According to FIG. 6, the spring-loaded terminal connection additionally has a manual actuating element 6 that is designed as a pivotable actuating lever. The manual actuating element 6 again has a manual actuating section 60. Starting from the manual actuating section 60, the actuating element 6 forks into two spaced apart actuating arms 61, which again have, at their free ends, a spring action section for acting on the clamping leg 43 or the actuating sections 44.

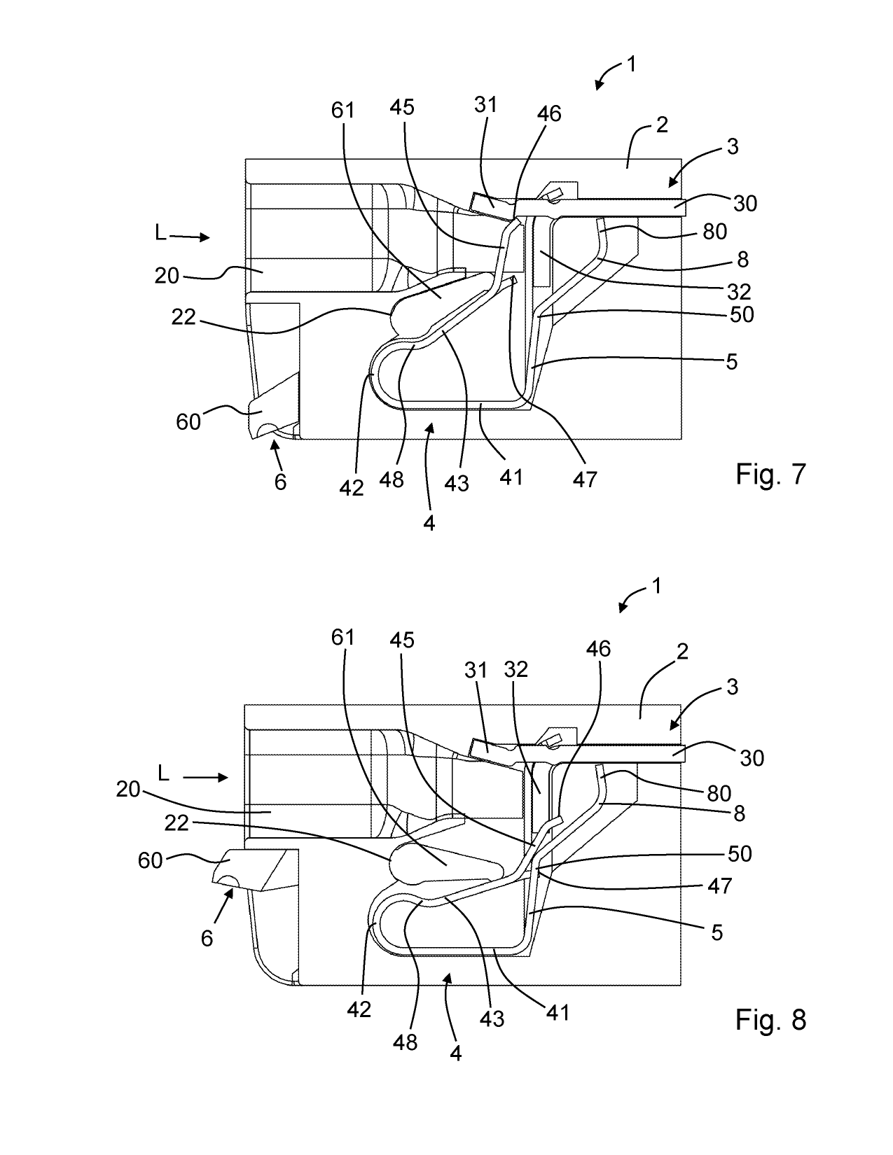

FIG. 7 shows a conductor connection terminal 1 with an insulating housing 2 in which is incorporated a spring-loaded terminal connection in accordance with FIG. 6. It can be seen that the manual actuating element 6 with the manual actuating section 60 projects at one housing side of the insulating housing 2 or at least is to be actuated at this housing side where the conductor insertion opening 20 is also arranged. Formed in the insulating housing 2 is a bearing receptacle 22 at which the actuating element 6 is supported so as to be pivotable about a pivot axis. The depression 48 on the clamping spring 4 can be used for space-saving design of this support, which is to say a part of the bearing area of the actuating element 6 can project into this depression 48. FIG. 7 shows the conductor connection terminal 1 with the spring-loaded terminal connection in the clamping position.

FIG. 8 shows the conductor connection terminal from FIG. 7 after transitioning of the spring-loaded terminal connection into the open position. The clamping leg 43 is latched onto the holding element 5 in this case. The release of the clamping leg 43 from the latched position can again be accomplished by inserting an electrical conductor into the conductor connection terminal 1 and exerting an actuating force on the release section 80 via the electrical conductor, as explained on the basis of FIGS. 3 and 4.

In the example described above, in each case the attachment section 7 is formed in one piece with the clamping spring 4 in that the attachment section 7 adjoins the holding section 41 as one piece. In an example, the attachment section 7 can be designed as a separate component that can be coupled to the holding section 41, for example by an interlocking connection at its end facing the holding section 41. In this example, the holding element 5 with the release element 8 can again be formed in one piece with the attachment section 7, as explained previously.

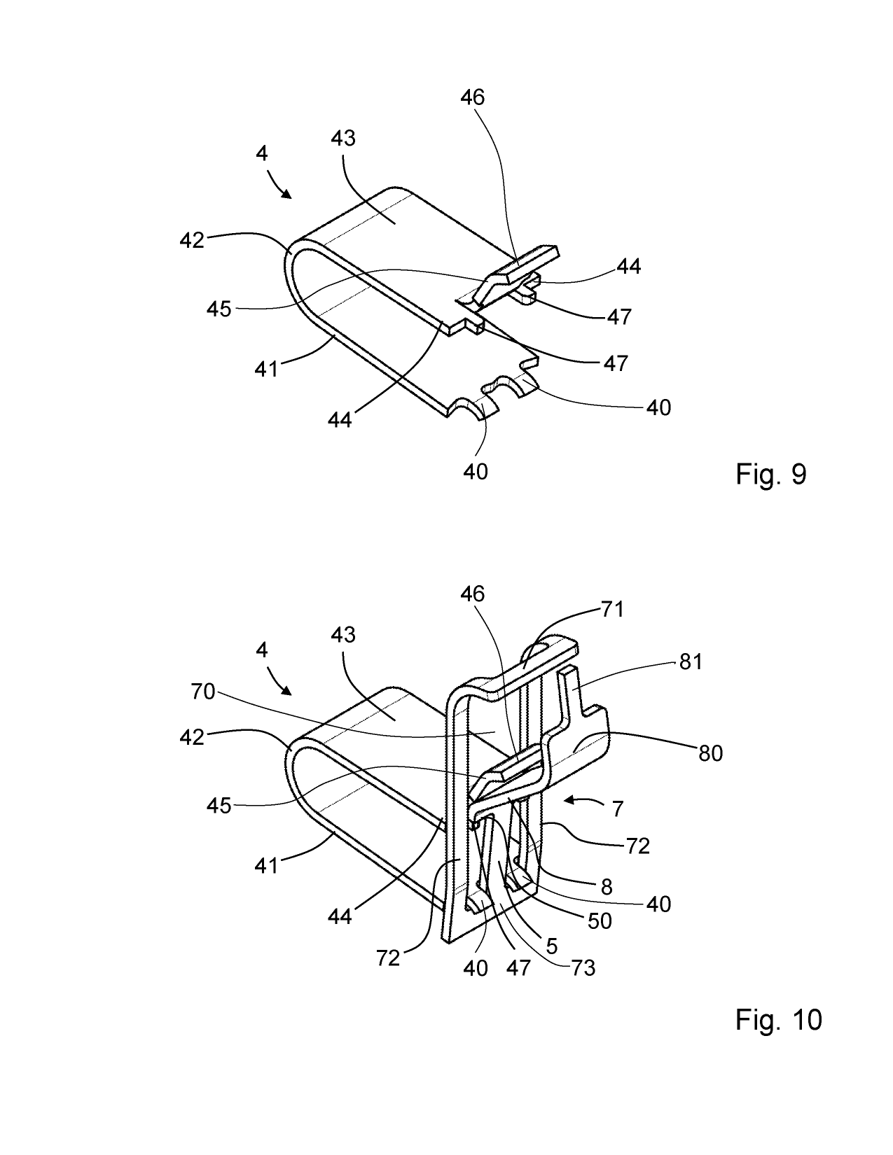

An example of such a conductor connection terminal 1, in which the clamping spring 4 and the attachment section 7 are designed as separate components, is described on the basis of FIGS. 9 to 13. With the exception of the differences explained below, the conductor connection terminal 1 can be designed the same way as one of the above-described conductor connection terminals, in particular the examples in FIGS. 1 to 4.

Here, the holding element 5 and the release element 8 can be formed in one piece with the attachment section 7, as in the above-described examples, so that a subassembly composed of two components results, as FIGS. 9 and 10 show, that can be designed comparably to the above-explained one-piece subassembly with the clamping spring 4, the attachment section 7, the holding element 5, and the release element 8.

In the region of the holding section 41 facing the attachment section 7, the clamping spring 4 can have one or more connecting sections 40, for example in the form of projecting extensions, with which the holding section 41 can be hooked onto a spring mount section 73 of the attachment section 7. The functionality of the clamping spring 4, and of the attachment section 7, the holding element 5, and the release element 8 can otherwise be designed in the same way as described above for the other examples.

In addition, another possibility for modification of the conductor connection terminal 1, which can also be used with the examples in FIGS. 1 to 8 explained above, is described on the basis of FIGS. 9 to 13. As can be seen in FIG. 10, an additional unlocking section 81 that serves to manually unlock the clamping leg 43 in the latched open position, even without an electrical conductor exerting a release force on the release section 80, can be formed on the release element 8, for example on the release section 80. For example, the unlocking section 81 can be designed as an extension projecting from the release section 80 in the direction of an outside of the insulating housing 2.

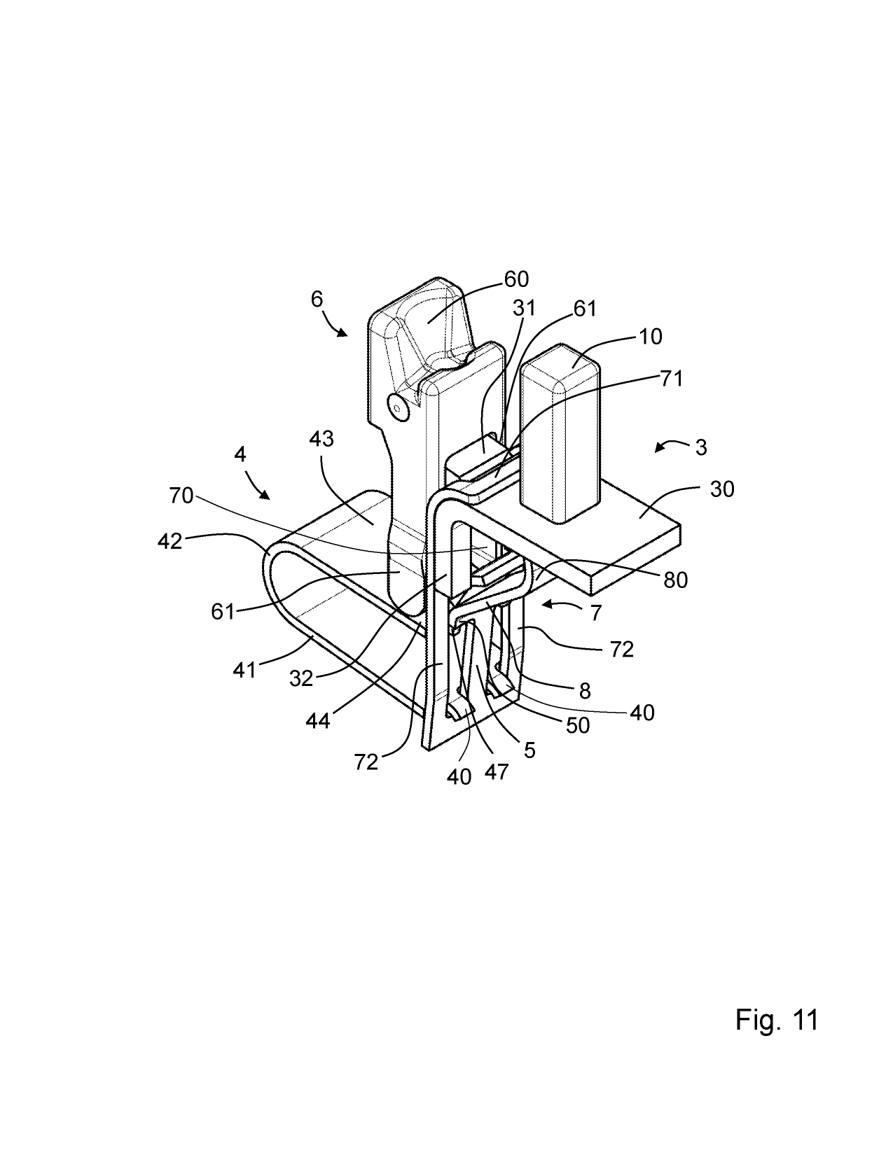

As FIG. 11 shows, the conductor connection terminal 1 can then have, as an additional component, an unlocking actuator 10, which constitutes an additional, manually actuatable component of the conductor connection terminal 1, which is to say in addition to the manual actuating element 6. The unlocking actuator 10 can be designed as, for example, a button to be actuated by a compressive force. Alternatively to the design as a pushbutton, the unlocking actuator 10 can also be implemented as a slide element.

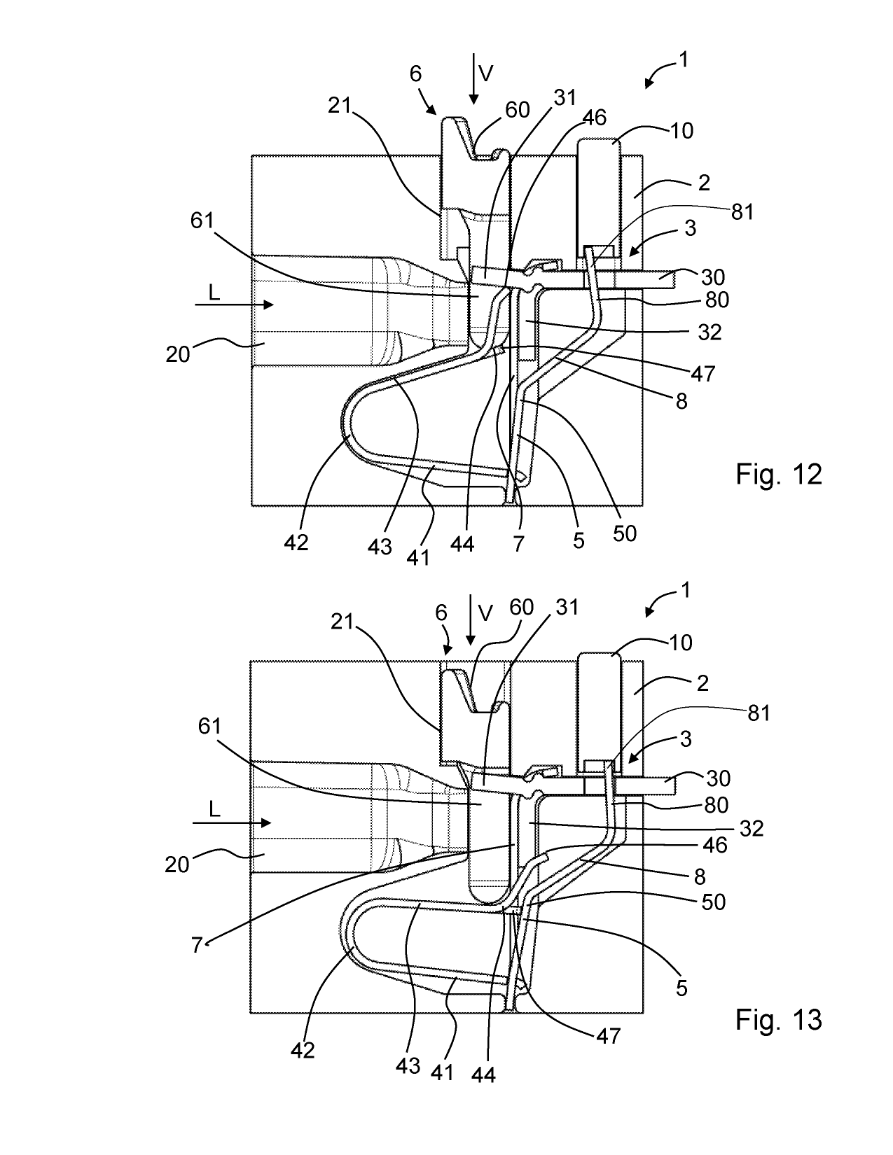

Via the lateral sectional views, FIGS. 12 and 13 show the interaction between the unlocking section 81 and the unlocking actuator 10. In FIG. 13, the clamping leg 43 is in the latched open position, which is to say the second latching elements 47 are latched onto the first latching elements 50. If this latching is now to be carried out manually without inserting an electrical conductor or in the event of an electrical conductor that is not flexurally rigid, a compressive force can be applied by the user to the unlocking actuator 10 on the outside of the insulating housing 2. As a result, the release section 80, and thus the release element 8, is deflected in a comparable manner to the regular actuation of the release section 80 by the inserted electrical conductor, so that the latching between the second latching elements 47 and the first latching elements 50 is terminated and the clamping leg 43 accordingly rebounds into the clamping position, as shown in FIG. 12.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A spring-loaded terminal connection for connecting at least one electrical conductor via spring force, the spring-loaded terminal connection comprising:
at least one bus bar; and
a clamping spring,
wherein the bus bar has a contact section for clamping the electrical conductor,
wherein the clamping spring has a clamping leg with a clamping edge to press the electrical conductor against the contact section,
wherein the clamping spring has a spring bend adjoining the clamping edge and has, adjoining the spring bend, a holding section that is attached to the bus bar via an attachment section,
wherein the attachment section is angled toward the contact section with respect to the holding section, and
wherein the bus bar has at least one projecting support arm, against which at least a part of the attachment section comes to rest and is supported as a result.

2. The spring-loaded terminal connection according to claim 1, wherein the attachment section has at least one through opening through which the electrical conductor that is to be clamped is adapted to be fed.

3. The spring-loaded terminal connection according to claim 2, wherein the attachment section has two spaced apart, narrow, elongated tension arms, between which is formed an intermediate space, creating the at least one through opening through which the electrical conductor that is to be clamped is adapted to be fed.

4. The spring-loaded terminal connection according to claim 1, wherein the bus bar has at least two spaced apart, projecting support arms, against each of which at least a part of the attachment section comes to rest and is supported as a result.

5. The spring-loaded terminal connection according to claim 4, wherein the clamped electrical conductor is passed through between the two spaced apart, projecting support arms.

6. The spring-loaded terminal connection according to claim 4, wherein a respective support arm makes contact with a tension arm, associated with the support arm, of the attachment section.

7. The spring-loaded terminal connection according to claim 1, wherein the electrical conductor to be clamped is to be inserted into the spring-loaded terminal connection in a conductor insertion direction that runs essentially parallel to the longitudinal extent of the contact section.

8. The spring-loaded terminal connection according to claim 3, wherein the attachment section extends from the holding section toward the contact section at an angle to the conductor insertion direction in a range from 60° to 120°, or in the range from 80° to 100°.

9. The spring-loaded terminal connection according to claim 1, wherein the attachment section is formed in one piece with the clamping spring or with the holding section or is designed as a separate component.

10. The spring-loaded terminal connection according to claim 1, wherein at least one actuating section is formed on the clamping leg, at which section the clamping leg is adapted to, through action by an actuating element, be shifted from a clamping position into an open position in which the clamping edge of the clamping leg is moved away from the contact section relative to the clamping position.

11. The spring-loaded terminal connection according to claim 10, wherein the at least one actuating section extends at an angle to the conductor insertion direction in the range from +/- 30°, at least in the open position.

12. The spring-loaded terminal connection according to claim 1, wherein the spring-loaded terminal connection has a manual actuating element for shifting the clamping leg into the open position, and wherein the manual actuating element has a manual actuating section at which the manual actuating element is to be actuated manually.

13. The spring-loaded terminal connection according to claim 12, wherein the manual actuating element forks, starting from the manual attachment section, into two spaced apart, essentially parallel actuating arms, each of which has a spring action section for the application of force to an actuating section of the clamping spring.

14. The spring-loaded terminal connection according to claim 12, wherein the spring-loaded terminal connection has, as a manual actuating element, a displaceable actuating pusher that is movable in a direction of displacement.

15. The spring-loaded terminal connection according to claim 14, wherein the direction of displacement of the actuating pusher extends at an angle to the conductor insertion direction in a range from 60° to 120° or in the range from 80° to 100°.

16. The spring-loaded terminal connection according to claim 12, wherein the spring-loaded terminal connection has a pivotable actuating lever as a manual actuating element.

17. The spring-loaded terminal connection according to claim 16, wherein the manual actuating section of the actuating lever projects from the spring-loaded terminal connection at the side of the spring bend of the clamping spring.

18. The spring-loaded terminal connection according to claim 1, wherein the spring-loaded terminal connection has a holding element to hold the clamping leg in the open position.

19. The spring-loaded terminal connection according to claim 18, wherein the spring-loaded terminal connection has a release element with a release section, via which the clamping leg held on the holding element is adapted to be released from the holding element when a release force is applied to the release section.

20. The spring-loaded terminal connection according to claim 18, wherein the release element is formed in one piece with the holding element.

21. The spring-loaded terminal connection according to claim 18, wherein the release section is arranged behind the attachment section in the conductor insertion direction.

22. The spring-loaded terminal connection according to claim 18, wherein the holding element is formed in one piece with the attachment section.

23. The spring-loaded terminal connection according to claim 1, wherein the bus bar has a main body that is designed as an elongated, flat, essentially smooth sheet metal part and/or that constitutes the majority of the bus bar, and wherein the contact section projects essentially in a straight line from the main body.

24. The spring-loaded terminal connection according to claim 1, wherein the attachment section engages behind the bus bar on a side facing away from the clamping leg.

25. A conductor connection terminal comprising:
an insulating housing; and
the spring-loaded terminal connection according to claim 1, the spring-loaded terminal connection being arranged at least mostly in the insulating housing, and
wherein the insulating housing has a conductor insertion opening through which an electrical conductor is adapted to be guided in the conductor insertion direction to a clamping point between the contact section and the clamping edge.
